(19) United States
(12) Patent Application Publication
(10) Pub. No.: US 2006/0285737 A1
(43) Pub. Date: Dec. 21, 2006

(54) Image-based artifact reduction in PET/CT imaging

(76) Inventors: James J. Hamill, Knoxville, TN (US); David D. Faul, Knoxville, TN (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/443,533

(22) Filed: May 30, 2006

Related U.S. Application Data
(60) Provisional application No. 60/691,811, filed on Jun. 17, 2005.

(51) Int. Cl. G06K 9/00

(52) U.S. Cl. 382/131

(57) ABSTRACT

A method for reducing image-based artifacts in combined positron emission tomography and computed tomography (PET/CT) scans. The method includes identifying pixels in a CT image having a large HU value, identifying a region surrounding the pixels, and modifying a value of each pixel within the region.

### CROSS-REFERENCE TO RELATED APPLICATIONS

This application claims priority from U.S. Provisional Ser. No. 60/691,811 titled “Image Based Artifact Reduction In PET/CT Imaging” filed on Jun. 17, 2005, the entire contents of which is incorporated herein by reference.

### BACKGROUND OF THE INVENTION

1. Field of Invention

The present invention pertains to the field of medical imaging using combined Positron Emission Tomography (PET) and Computed Tomography (CT) modalities. More particularly, this invention is directed toward a method for reducing image-based artifacts in a PET/CT scan.

2. Description of the Related Art

In the field of combined Positron Emission Tomography and Computed Tomography (PET/CT), it is well known that difficulties are often encountered in computing the attenuation correction factors used. Normally this computation is performed as a digital calculation in computers used for PET/CT. The typical procedure for deriving attenuation correction factors (ACF) in PET/CT is as follows.

First, CT images I(X,Y,Z) are generated to represent attenuation coefficients at X-ray energies. These are derived from measurements in which X-rays pierce through the body on straight lines, the X-rays that pass completely through the body are detected, and the detected X-rays are used to reconstruct CT images. The CT images consist of a matrix of data where the datum from one element of the matrix is a pixel whose value is related to attenuation coefficients at that position.

Second, the CT pixel values are converted to attenuation values (mu map) for the more energetic 511 keV radiation used in PET.

Finally, the ACF is generated by integrating the mu map along a subset of the straight lines along which the PET tomograph makes its measurements.

Errors arise in the first step, in which the CT pixel values are incorrect, so that they cannot be converted accurately to mu map pixel values. To date, this problem has not been resolved as a part of PET processing. Specifically, this problem has not been resolved in the step of converting the pixel values to attenuation values. Thus, there is a need to resolve this problem.

Medical X-ray CT tomographs are designed to perform best when imaging soft tissue in the human body. This material comprises only the lightest chemical elements, mostly hydrogen, carbon, nitrogen, and oxygen. In the case of medical X-ray tomographs, the presence of cortical bone in the field of view requires a second-pass correction to account for the different X-ray absorption mechanisms in the calcium and potassium present in the bones.

Sometimes CT images are corrupted by a piece of metal in the patient, for example surgical clips or prosthetic joints. These objects are in many cases radio-opaque, i.e. nearly all of the X-rays that strike them are absorbed by the metal. The resulting inaccuracies in the CT images are called metal artifacts. To address the metal-artifacts problem, the medical imaging literature presents processing techniques for creating an improved CT image in the presence of metal objects that are stationary, that is, that are unaffected by the patient's breathing or blood circulation. These methods are based on the knowledge that the metal moves a relatively small distance during the measurement. In one conventional approach to the problem, as discussed by G. H. Glover et al., “An algorithm for the reduction of metal clip artifacts in CT reconstructions,” Medical Physics, 8(6), 799-807 (November/December 1981), the X-ray sinogram is repaired using an interpolation method, in which the sinogram values known to be corrupt are replaced with an estimate based on sinogram values known to be substantially free of measurement errors. Recently, iterative approaches have been proposed as improvements on that approach. See B. De Man et al., “Reduction of metal streak artifacts in x-ray computed tomography using a transmission maximum a posterior algorithm,” IEEE Transactions on Nuclear Science, vol. 47, nr. 3, 977-981 (2000).

However, it has been found that these methods do not work well when the metal moves during the measurement. Thus, concerns exist about performing PET/CT studies of the heart in cases where an automated implanted cardioverter defibrillator (AICD) is present in the patient's chest. These devices are designed to restore the normal cardiac rhythm in the event of a potentially life-threatening arrhythmia. FIG. 1 illustrates such a device.

Like a pacemaker, the AICD moves inside the chest with the heart's beating motion. For CT machines, an AICD device presents more serious difficulties than a pacemaker. It contains two shocking coils of platinum wire, about 3 mm in diameter, large enough to block all or substantially all the X-rays on some lines of response. One of the coils is positioned adjacent to the right ventricular wall, close to the septal wall and the free walls of the left and right ventricles, which are imaged in cardiac PET. When a CT machine reconstructs a section with the moving coil, the result is a metal artifact, with spurious high and low CT values in the region around the coil's actual location. This is illustrated in the FIG. 2 by the arrow.

There are at least two consequences. First, the CT image is an inaccurate picture of the anatomy. For example, in the illustration of FIG. 2, the coil is not shown in the correct position. Second, the PET portion of the PET/CT image may contain incorrect values. This happens because the PET image is derived from a combination of the PET emission measurement, and ACF's derived from the flawed CT image. This problem was not noticed in the generation of PET prior to PET/CT, because ACF's derived with a 511-keV transmission source are little affected by the presence of 3-mm coils of platinum.

J. F. Williamson et al., “Prospects for quantitative computed tomography imaging in the presence of foreign metal bodies using statistical image reconstruction,” Medical Physics 29(10) 2404-18 (2002), discusses a further iterative reconstruction approach for reducing artifacts.

A. H. R. Lonn et al., “Evaluation of method to minimize the effect of X-ray contrast in PET/CT attenuation correction,” Proceedings of the 2003 IEEE Medical Imaging Conference, M6-146 (Portland, Oreg.), discusses a simple thresholding approach for PET/CT.

U.S. Pat. No. 6,721,387, issued to Naidu et al., on Apr. 13, 2004, discloses a method of reducing metal artifacts in CT. The method of the '387 patent include the steps of:
A. generating a preliminary image from input projection data collected by the CT system;
B. identifying metal objects in the preliminary image;
C. generating secondary projections from the input projection data by removing projections of objects having characteristics that may cause the objects to be altered in a final artifact-corrected image;
D. extracting the projections of metal objects identified in step B from the secondary projection data generated in step C;
E. generating corrected projections by removing the projections of the metal objects extracted in Step D from the input projection data; and
F. generating a final image by reconstructing the corrected projections generated in step E and inserting the metal objects identified in Step B into the final image.

### BRIEF SUMMARY OF THE INVENTION

The present invention is provided for reducing errors in cardiac PET/CT in the case where an AICD is present in the patient's chest. Because the invention is simple and robust, it can be applied to other cases in which the ACF cannot be accurately derived from the CT images.

In an aspect of the invention, the method provides for identifying pixels in a CT image having a large HU value, identifying a region surrounding the pixels, and modifying a value of each pixel within the region.

In another aspect of the present invention, the method provides for modifying the pixels in the CT image having a large HU value using a reassignment function of the original HU values that is continuous and smooth.

In a further aspect of the invention, the method provides for before said modifying a value of each pixel within the region, identifying an original value of each bone pixel within the region, and after modifying a value of each pixel with the region, replacing each modified value of each bone pixel with the original value of each bone pixel.

In still a further aspect of the invention, the method provides for after said identifying a region, morphologically dilating the region surrounding the pixels to enhance accuracy.

In another aspect of the present invention, the method provides for after morphologically dilating the region, eroding the region surrounding the pixels.

In a further aspect of the present invention, the method provides for identifying pixels in the CT image having an HU value below a defined threshold and which are proximate to the region surrounding the pixels having a large HU value, and adjusting the pixels in having an HU value below a defined threshold to a new value

### BRIEF DESCRIPTION OF THE DRAWINGS

The above-mentioned features of the invention will become more clearly understood from the following detailed description of the invention read together with the drawings in which:

FIG. 1 is an illustration of an automated implanted cardioverter defibrillator (AICD) present in a patient's chest in accordance with the prior art;

FIG. 2 is an illustration of a typical metal artifact caused by an AICD similar to that illustrated in FIG. 1 in accordance with the prior art;

FIGS. 3A through 3D illustrate graphically a CT image before and after the application of the image-based artifact reduction (IBAR) with line profiles indicating the CT pixel values before and after in accordance with an embodiment of the present invention; and

FIG. 4 is a flowchart illustrating a process for performing an exemplary image-based artifact reduction (IBAR) in accordance with an embodiment of the present invention.

### DETAILED DESCRIPTION OF EXEMPLARY EMBODIMENTS OF THE INVENTION

Exemplary embodiments of image-based artifact reduction (IBAR) methods for combined positron emission tomography and computed tomography (PET/CT) scans. The present embodiments are useful in the case in which the CT measurement of a PET/CT scan is corrupted by artifacts such as a moving piece of metal. The situation of reducing metal artifacts alone is known as metal artifact reduction, or MAR.

The exemplary IBAR method modifies the pixel values I(X,Y,Z) in a series of CT image slices. The image values are specified in Hounsfield units (HU). Properly functioning CT equipment creates images in which water is assigned a value of zero (0 HU), air is assigned a value of approximately −1000 HU, and bone and metal are assigned values greater than zero (0 HU). In the PET/CT processing software that has been used, images are first reduced from arrays of size 512×512 pixels to size 256×256 with a rebinning procedure, in which groups of four pixels in the 512×512 matrices are averaged, and those average values are placed in single image pixels in the 256×256 matrix. The exemplary IBAR method is applied to the series of 256×256 images. However, the exemplary IBAR does not require a particular matrix size, and it can be used with or without modifications such as the rebinning procedure described above.

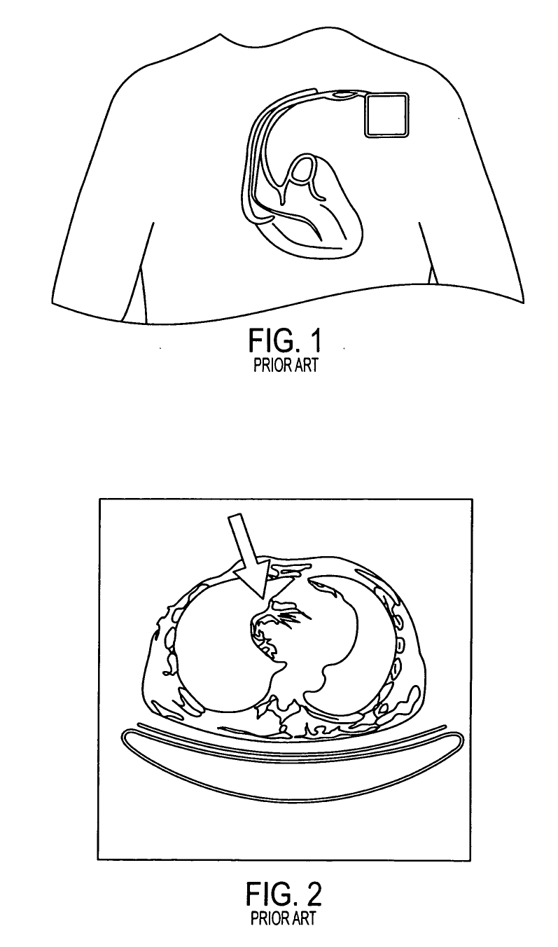

Many of the image pixels affected by the metal artifact are reconstructed with a high HU value. A set of such high pixels is prominent in FIG. 2 as a collection of streaks.

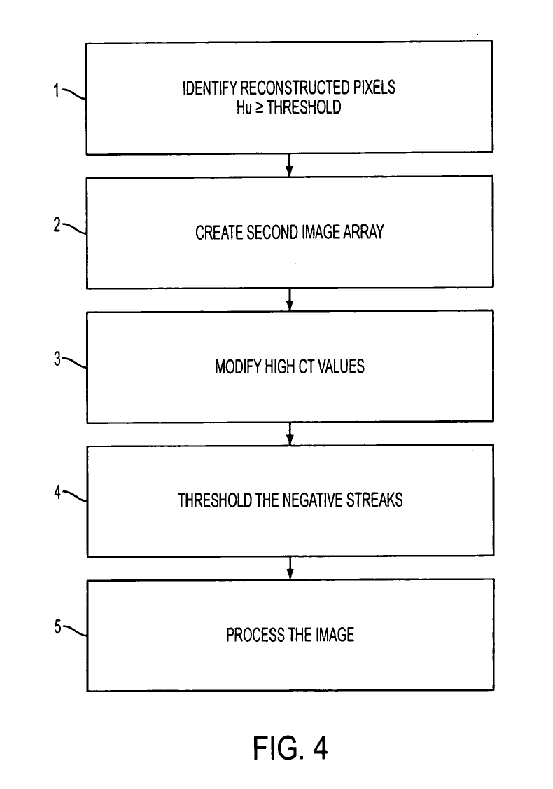

FIG. 4 is a flowchart illustrating a process for performing an exemplary image-based artifact reduction (IBAR) in accordance with an embodiment of the present invention. In step 1 of the exemplary IBAR method, all pixels that have a reconstructed HU value greater than or equal to 900 HU are identified. While the value 900 HU is a preferred value for an adjustable parameter of the IBAR method, it should be understood by those skilled in the art that other values may be used and still fall within the scope of the present invention. This procedure results in an image array called STREAK(X,Y,Z), in which the values at or above this threshold are given the value 1 and values below it are given the value 0. The STREAK(X,Y,Z) array commonly includes some pixels that represent bone.

In step 2, a second image array NEAR_STREAK(X,Y,Z) is then created. This array is created by using the morphological operation of dilation on STREAK (X,Y,Z). The image array identifies all image pixels that lie within 2 pixels of the streaks identified in step I. Although a 2 pixel range is disclosed, it should be appreciated by those skilled in the art that other values may be used and still fall within the scope of the present invention. This pixel range is related to an overall width of the dilation kernel through the equation:
kernel_halfWidth=2×kernel_width+1.
This may also be specified as a distance in millimeters which is converted to pixels through the conversion formula:
(distance in pixels)=(distance in mm)/(pixel size in mm).
Other methods equivalent to dilation within the scope of the present invention include, for example, smoothing of STREAK_IMAGE(X,Y,Z). The extension of the dilation kernel into three dimensions is based on constructing collections of image voxels with an approximate spherical shape. In an embodiment of the present invention, the dilation works three dimensionally, so that a streak in one image slice creates “near streaks” pixels in neighboring slices. Pixels close to the streaks are assigned the value 1; pixels not close to the streaks are assigned the value 0.

Next, in step 3, the high CT image values are modified. This procedure is mathematically similar to thresholding, i.e. setting the large pixel values to a limiting value. This is accomplished in any of several ways. The exemplary IBAR method uses the following steps.

Pixel values below THRESHOLD1 are not modified. The IBAR method uses the parameter value THRESHOLD1=0 HU. However, it should be appreciated by those skilled in the art that other values may be used and still fall within the scope of the present invention.

A quadratic interpolation method is used for pixel values between THRESHOLD1 and (2×THRESHOLD2—THRESHOLD1). Those values, I(X,Y,Z) are replaced with the values:

$$\begin{matrix}THRESHOLD 1 + \\ ( I ( X , Y , Z ) - THRESHOLD 1 ) \times \\ [ 1 - \frac{I ( X , Y , Z ) - THRESHOLD 1}{ 4 ( THRESHOLD 2 - THRESHOLD 1 )} ]\end{matrix}$$

The IBAR method uses the parameter value THRESHOLD2=100 HU. However, it should be appreciated by those skilled in the art that other values may be used and still fall within the scope of the present invention.

Pixel values greater than (2×THRESHOLD2—THRESHOLD1) are set to the value THRESHOLD2. In an embodiment of the present invention, the parameters THRESHOLD1 and THRESHOLD2 are adjustable.

As a result of this reassignment technique, the new pixel values are related to the original pixel values by a relationship that is continuous and smooth. Smoothness implies that the derivatives of the reassignment function are continuous functions of the original HU values.

This step also generates an array SOFT_TISSUE(X,Y,Z). In this array, all pixels which originally had the value THRESHOLD1 or greater are set to 1, the other pixels to 0. This array is morphologically dilated, as in step 2. The dilation structure is allowed to have other dimensions although, in one embodiment of the present invention, it is the same as in step 2. Following dilation, it is eroded with the morphological operation of erosion, using the same structure for erosion as for dilation. The dimensions of the dilation and erosion structures are adjustable parameters of the present invention. The resulting array identifies those parts of the CT image which represent the density of soft tissues or bone, while it excludes lung tissue and the region outside of the patient. The combination of dilation and erosion is well known in the image processing community as a technique which isolates small anomalous regions.

Step 4 includes thresholding of negative streaks. The metal artifact in the uncorrected CT image has two components. The first component is the set of pixels with anomalously large HU values, typically arranged in streaks extending across the image arrays and between image planes. These are reduced by step 3 using the IBAR method, described above. Second, there are pixels with anomalously small HU values, commonly lying in close proximity to the positive streaks. Some pixels in this class are visible as black regions near the streaks in FIG. 2. The worst of these negative streaks are next reduced. In this step, all pixels whose value is less than THRESHOLD3, and at the same time are in a region where NEAR_STREAK(X,Y,Z) has the value 1 and SOFT_TISSUE(X,Y,Z) has the value 1, are replaced with the value (THRESHOLD1+THRESHOLD2)/2. The IBAR method uses the parameter value THRESHOLD3=−100HU. In this step, the THRESHOLD3 parameter is adjustable.

Finally, in step 5, the image is processed to smooth the modified CT map. In this step, uneven edges are smoothed in the three dimensional CT image. This is accomplished using a three dimensional median filter with a 3-pixel extent in the transverse plane, and also a 3-slice extent in the direction between planes. The spatially variable median filter is just one of the possible ways of smoothing the modified CT images. Also, the 3×3×3 dimensions of the kernel that it uses are parameters chosen for this implementation of the exemplary IBAR method. In general, those dimensions are specified in terms of millimeters and converted to pixels and plane spacing in the implementation. The 3D median filtering step is computationally intensive, and would be much more so if the image had more pixels, e.g. 512×512, while the kernel size were kept at the same size as measured in millimeters. The median filter is only applied where the SOFT_TISSUE(X,Y,Z) array value is 1. By applying the 3D median filter only close to the soft tissue as described above, performance is accelerated. In yet another embodiment of the exemplary IBAR method, the median filter is applied in a region identified as soft tissue, then dilated, but not yet eroded. At the end of this step, the CT images are used in a conventional manner for PET/CT processing.

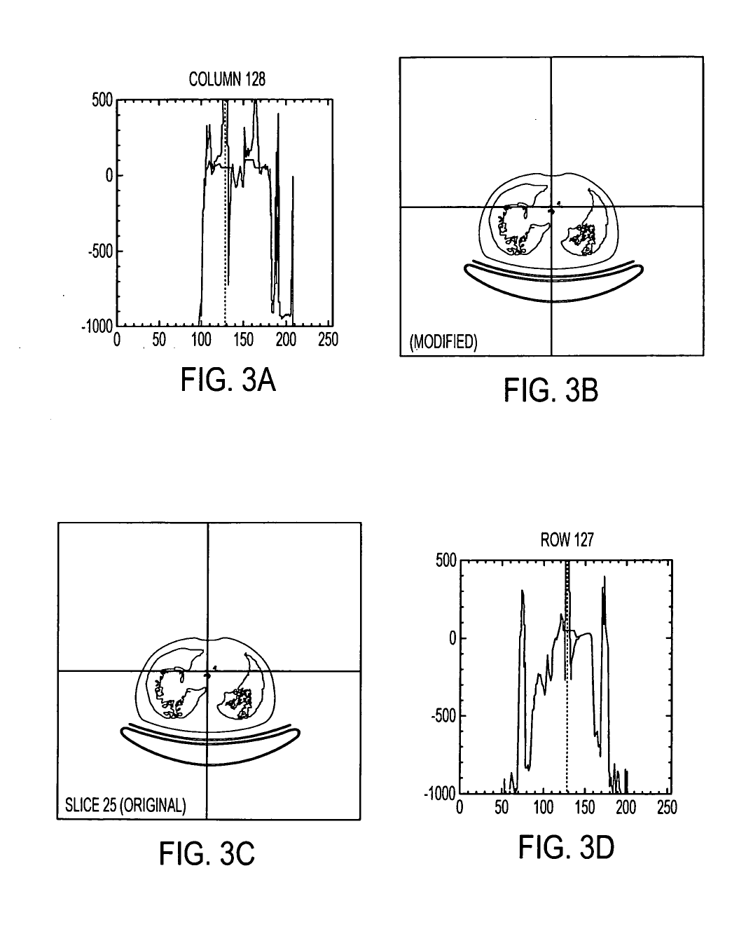

A comparison of CT images before and after application of the exemplary IBAR method, and profiles through the metal artifact, are shown in FIG. 3. The graphical data illustrations show both the HU values in the original image and in the modified one. The corresponding images are shown below. The modified image FIG. 3B and graph FIG. 3A in accordance with an embodiment of the present invention depict a much sharper image which is smoother graphically compared to the prior art image 3C and prior art graph 3D.

It will be understood that the exemplary method of the present invention reduces metal artifact without the steps of thresholding negative streaks and processing the image to smooth the CT map. However, these steps serve to provide a higher quality image.

The exemplary method of the present invention further provides for the identification of bone pixels. In this exemplary method, original values of the bone pixels are identified and then replaced after processing as described above.

From the foregoing description, it will be recognized by those skilled in the art that an exemplary method for reducing image-based artifacts in PET/CT scans has been provided.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, I claim:

1. A method for reducing image-based artifacts in a tomography scan having as a component a computed tomography (CT) image, said method comprising the steps of:
(i) identifying pixels in the CT image having a large Hounsfield units (HU) value;
(ii) identifying a region surrounding said pixels; and
(iii) modifying a value of each pixel within said region.

2. The method of claim 1 further comprising the step of modifying said pixels in the CT image having a large HU value using a reassignment function of the original HU values that is continuous and smooth.

3. The method of claim 2, wherein said method is used to generate attenuation correction factors in PET/CT.

4. The method of claim 3, before said step of modifying a value of each pixel within said region, further comprising the step of identifying an original value of each bone pixel within said region, and after said step of modifying a value of each pixel with said region, further comprising the step of replacing each modified value of each bone pixel with the original value of each bone pixel.

5. The method of claim 1, after said step of identifying a region, further comprising the step of morphologically dilating said region surrounding said pixels to enhance accuracy.

6. The method of claim 5, after said step of morphologically dilating said region, further comprising the step of eroding said region surrounding said pixels.

7. The method of claim 1, wherein said method is used to generate attenuation correction factors in at least one of a PET and a CT.

8. The method of claim 7 further comprising the step of identifying an original value of each bone pixel within said region, and replacing each modified value of each bone pixel with the original value of each bone pixel.

9. The method of claim 7 further comprising the step of modifying said pixels in the CT image having a large HU value using a reassignment function of the original HU values that is continuous and smooth.

10. The method of claim 9 further comprising the steps of:
(i) identifying pixels in the CT image having an HU value below a defined threshold and which are proximate to said region surrounding said pixels having a large HU value; and
(ii) adjusting said pixels having an HU value below a defined threshold to a new value.

11. The method of claim 10 further comprising the step of smoothing an image acquired from said adjusted pixels using a spatial filter.

12. The method of claim 11, wherein said spatial filter is a three-dimensional median filter.

13. The method of claim 1 further comprising the step of morphologically dilating said region surrounding said pixels to enhance accuracy.

14. The method of claim 13 further comprising the step of eroding said region surrounding said pixels.

15. The method of claim 1, wherein said artifact comprises a metal based artifact.

16. The method of claim 12, wherein said three dimensional filter comprises a 3 pixel extent in a tranverse plane.

17. The method of claim 12 further comprising the step of applying the three dimensional filter is applied in a region identified as soft tissue

18. The method of claim 1 further comprising the step of converting pixel values to attenuation values.

19. The method of claim 18, wherein a radiation level is about 511 keV.

20. The method of claim 1, wherein the artifact is a result of at least one of a pacemaker and an automated implanted cardioverter defibrillator.
